(19) United States
(12) Patent Application Publication
(10) Pub. No.: US 2026/0295727 A1
(43) Pub. Date: Oct. 1, 2026

(54) OPTICAL FIBER ETCHING DEVICE

(71) Applicant: WuHan Raycus Fiber Laser Technologies CO., LTD, Wuhan, Hubei (CN)

(72) Inventors: Shaoyi FENG, Wuhan, Hubei (CN); Qixin ZHU, Wuhan, Hubei (CN); Dapeng YAN, Wuhan, Hubei (CN); Jianhong SHI, Wuhan, Hubei (CN); Zhongya HUANG, Wuhan, Hubei (CN); Yongkang ZHU, Wuhan, Hubei (CN); Feng LI, Wuhan, Hubei (CN)

(73) Assignee: WuHan Raycus Fiber Laser Technologies CO., LTD, Wuhan, Hubei (CN)

(21) Appl. No.: 18/992,634

(22) PCT Filed: Apr. 29, 2024
(86) PCT No.: PCT/CN2024/090638

§ 371 Date: Jan. 9, 2025

(30) Foreign Application Priority Data
Sep. 26, 2023 (CN) 202311244316.0

(51) Int. Cl. B23K 26/10; B23K 26/03; B23K 26/08; B23K 26/082; B23K 26/362

(52) U.S. Cl. CPC B23K 26/10; B23K 26/03; B23K 26/082; B23K 26/0869; B23K 26/362

(57) ABSTRACT

An optical fiber etching device is provided by the application. The optical fiber etching device includes a base, a clamping assembly, a tensile force measuring member for measuring a tensile force applied to an optical fiber, and an etching assembly. The clamping assembly includes two clamping members arranged on the base at intervals in a first direction and used for clamping the optical fiber. The etching assembly includes a laser for generating laser light and a moving mechanism. The moving mechanism is connected to the laser and configured for driving the laser to move so that the laser light etches the optical fiber along a length direction of the optical fiber.

This application claims priority to Chinese Patent Application No. 202311244316.0, filed with the Chinese Patent Office on Sep. 26, 2023, the entire contents of which are incorporated herein by reference.

### TECHNICAL FIELD

The present application relates to the field of laser technologies, and more particularly, to an optical fiber etching device.

### BACKGROUND

In the structure of the laser, the optical fiber beam combiner is an important optical device whose main function is to synthesize light beams and thus increase the output power. The manufacturing process performed by optical fiber beam combiners is generally to strip coating layers of optical fibers and then arrange the optical fibers together in a certain form, and these arranged optical fibers are heated and melted at a high temperature so that the multiple optical fibers are fused together.

In order to make the optical fibers to more stably fuse together, it is generally necessary to treat the surfaces of the optical fibers, and to remove a part of each of the surfaces of the optical fibers, so as to form an adjoining surface at the surface of each optical fiber. The optical fibers are fused very good by adjoining the adjoining surfaces of two adjacent optical fibers together.

However, in the prior art, the precision of the adjoining surface formed at the surface of the optical fiber is lower, so that the adjoining surfaces of the two adjacent optical fibers cannot be accurately adjoined together, thereby affecting the fusing effect between the two adjacent optical fibers.

### SUMMARY

Embodiments of the present application provide an optical fiber etching device, and aims to solve a problem in the prior art that an accuracy of an adjoining surface formed at a surface of an optical fiber is relatively low.

Embodiments of the present application provide an optical fiber etching device including:

a base;

a clamping assembly including two clamping members arranged on the base at intervals in a first direction, in which the two clamping members each includes a connecting seat arranged on the base, and a clamper movably connected with the connecting seat; the clamper has a clamping position and a releasing position; when the clamper is in the clamping position, a clamping space for clamping an optical fiber is formed between the clamper and the connecting seat; when the clamper is in the releasing position, the optical fiber is released; the connecting seat of each of the two clamping members is slidably connected with the base in the first direction, and the clamping space of each of the two clamping members extends in the first direction; and the clamping space of one of the two clamping members coincides with the clamping space of another one of the two clamping members in the first direction;

two tensile force measuring members for measuring a tensile force applied to the optical fiber, in which the two tensile force measuring members are each provided on the base and are each connected to the connecting seat of a corresponding one of the two clamping members;

a torsional force measuring member including a torsional force sensor, in which the torsional force sensor is provided on a side of the clamper facing toward the clamping space or a side of the connecting seat facing toward the clamping space;

an etching assembly including a laser for generating laser light and a moving mechanism, in which the moving mechanism is connected to the laser and configured for driving the laser to move so that the laser light etches the optical fiber along a length direction of the optical fiber.

In some embodiments, the one or more adsorption holes include a plurality of adsorption holes, and the plurality of the adsorption holes are sequentially distributed at intervals in the first direction.

Embodiments of the present application further provide an optical fiber etching device including:

a base;

a clamping assembly including two clamping members arranged on the base at intervals in a first direction, in which the two clamping members are configured for clamping an optical fiber;

one or more tensile force measuring members for measuring a tensile force to which the optical fiber is subjected;

an etching assembly including a laser for generating laser light and a moving mechanism, in which the moving mechanism is connected to the laser and configured for driving the laser to move so that the laser light etches the optical fiber along a length direction of the optical fiber;

a torsional force measuring member for measuring a torsional force to which the optical fiber is subjected; and

a positioning member disposed between the two clamping members of the clamping assembly, in which the positioning member includes a positioning groove extending in the first direction and extending through the positioning member, the positioning groove is configured for receiving the optical fiber, and an inner surface of the positioning groove is configured for abutting against an outer peripheral surface of the optical fiber.

In some embodiments, at least one of the two clamping members is slidably connected to the base in the first direction, and the tensile force measuring member is provided on the base and is connected to the clamping member slidably provided on the base, so as to detect the tensile force to which the clamping member is subjected.

In some embodiments, the two clamping members are slidably connected to the base in the first direction; the optical fiber etching device includes two of the one or more tensile force measuring members, and the two tensile force measuring members are provided on the base and are connected to the two clamping members in one-to-one correspondence.

In some embodiments, the two clamping members each include a connecting seat provided on the base, and a clamper movably connected to the connecting seat; the clamper have a clamping position and a releasing position; a clamping space for clamping the optical fiber is formed between the clamper and the connecting seat when the clamper is in the clamping position, and the optical fiber is released when the clamper is in the releasing position.

In some embodiments, the clamping space of each of the two clamping members extends in the first direction.

In some embodiments, the optical fiber etching device further includes a torsional force measuring member for measuring a torsional force to which the optical fiber is subjected.

In some embodiments, the two clamping members each include a connecting seat provided on the base, and a clamper movably connected to the connecting seat; the clamper have a clamping position and a releasing position; a clamping space for clamping the optical fiber is formed between the clamper and the connecting seat when the clamper is in the clamping position, and the optical fiber is released when the clamper is in the releasing position; and the torsional force measuring member includes a torsional force sensor provided on a side of the clamper facing toward the clamping space or a side of the connecting seat facing toward the clamping space.

In some embodiments, the laser includes a carbon dioxide laser.

In some embodiments, the moving mechanism is configured for driving the laser to move along the length direction of the optical fiber, the laser includes a galvanometer assembly located in an optical path of the laser light, the galvanometer assembly is configured for converting the laser light into a scanning laser light, and a scanning direction of the scanning laser light is at an included angle with respect to the length direction of the optical fiber.

In some embodiments, the positioning member is made of a metallic material.

In some embodiments, the laser is located on a side of the positioning member, and the laser light generated by the laser is configured to etch away a portion of the optical fiber protruding out of an opening of the positioning groove and to retain a portion of the optical fiber located in the positioning groove.

In some embodiments, the laser is opposite to an opening of the positioning groove.

In some embodiments, the inner surface of the positioning groove is provided with one or more adsorption holes configured for communicating with a suction member.

In some embodiments, the one or more adsorption holes include a plurality of adsorption holes, and the plurality of adsorption holes are sequentially distributed at intervals in the first direction.

In some embodiments, the positioning member includes a cavity extending in the first direction, a first end of each of the one or more adsorption holes is in communication with the positioning groove, and an other end of the adsorption hole is in communication with the cavity.

In some embodiments, an outer surface of the positioning member is protrudedly provided with a connector in communication with the cavity, and the connector is configured for communicating with the suction member so that the one or more adsorption holes are in communication with the suction member.

In some embodiments, the optical fiber etching device further includes a gas pressure sensor in communication with the one or more adsorption holes to detect gas pressure in the one or more adsorption holes.

In some embodiments, the gas pressure sensor is in communication with the connector.

In some embodiments, the pressure sensor is disposed within the cavity.

In the optical fiber etching device provided by embodiments of the present application, the tensile force to which the optical fiber is subjected to is measured by the tensile force measuring member. Further, the optical fiber is clamped by the clamping assembly and the tensile force applied to the optical fiber is adjusted before the optical fiber is etched by the optical fiber etching device, and then the tensile force applied to the optical fiber is measured by the tensile force measuring member. When the tensile force applied to the optical fiber is within a predetermined straightening range, it is indicated that the optical fiber is straightened, and then the optical fiber is etched by the etching assembly, thereby ensuring that the optical fiber remains in a straightened state in the process of etching the optical fiber. In this way, the accuracy of etching the optical fiber by the etching assembly is improved, and a high-precision adjoining surface is formed at the surface of the optical fiber.

Furthermore, two tensile force measuring members are connected to the two clamping members to measure the tensile force applied to the optical fiber, and a torsional force sensor is provided on a side of a clamper facing toward the clamping space or a side of a connecting seat facing toward the clamping space, so as to measure the torsional force applied to the optical fiber. After the optical fiber is clamped by the clamping assembly, whether the optical fiber is straightened or not, or whether the torsion occurs may be determined by determining whether the tensile force and the torsional force applied to the optical fiber are within a suitable range. The optical fiber is etched by the laser light when the optical fiber is straightened and is not torsional, so as to ensure that the optical fiber is etched by the laser light to form an adjoining surface when the optical fiber is straightened and is not torsional, thereby effectively improving the etching accuracy of the laser light on the adjoining surface of the optical fiber.

Further, a positioning member is provided between the two clamping members, the positioning member is provided with a positioning groove extending in the first direction, adsorption hole(s) communicating with the suction member are formed on the inner surface of the positioning groove, and the gas pressure in the adsorption hole(s) is detected by the pressure sensor. After the optical fiber is clamped between the two clamping members, the negative pressure may be applied to the absorption hole(s) through the suction member, so that the absorption hole(s) absorb the optical fiber between the two clamping members to the inner surface of the positioning groove. And, the air pressure in the absorption hole(s) is detected by the air pressure sensor. In this way, it may accurately determine whether the optical fiber is stably absorbed to the positioning groove according to the detected air pressure value, thereby positioning the optical fiber between the two clamping members, and maintaining the optical fiber in a straight state. So, the optical fiber is not deformed during etching the optical fiber through the etching assembly, and thus the accuracy of etching the optical fiber is further improved.

### BRIEF DESCRIPTION OF THE DRAWINGS

The technical solution and other beneficial effects of the present application will be apparent from the following detailed description of specific embodiments thereof, taken in conjunction with the accompanying drawings.

FIG. 1 is a schematic structural diagram of an optical fiber etching device according to an embodiment of the present application;

FIG. 2 is a schematic structural diagram of a positioning member according to an embodiment of the present application; and

FIG. 3 is a sectional view along a first direction in FIG. 2.

Optical fiber etching device 100; clamping assembly 110; clamping member 111; connecting seat 1111; second recess 1112; clamper 1113; first recess 1114; clamping space 1115; positioning member 112; positioning groove 1121; adsorption hole 1122; cavity 1123; connector 1124; optical fiber 200; and first direction X.

### DETAILED DESCRIPTION

The technical solution in the embodiments of the present application will be clearly and completely described with reference to the accompanying drawings. It will be apparent that the described embodiments are only part of the examples of the present application, and not all examples. Based on the embodiments in the present application, all other embodiments obtained by a person skilled in the art without involving any inventive effort are within the scope of the present application.

In the description of the present application, it is to be understood that the terms mentioned in the application, such as “center”, “longitudinal”, “transverse”, “length”, “width”, “thickness”, “upper”, “lower”, “front”, “behind, “left”, “right”, “vertical”, “horizontal”, “top”, “bottom”, “inside”, “outside”, “clockwise”, “counterclockwise”, etc. are only refer to the orientation or positional relationship of the accompanying drawings. The description is merely for the purpose of describing the present application and the simplification of the present application and does not indicate or imply that the device or component referred to has a specific orientation, operated in a specific orientation. Thus, it should not be construed as limiting the application. Moreover, the terms “first” and “second” are used for descriptive purposes only, and are not to be construed as indicating or implying relative importance or implicitly indicating the number of technical features indicated. Thus, features defined with “first” or “second” may include one or more of the described features either explicitly or implicitly. In the description of the present application, the meaning of “a plurality of” is two or more unless specifically defined otherwise.

In the description of the present application, unless otherwise expressly specified and limited, the terms “installed”, “conjoint”, and “connect” are to be understood in a broad sense, for example, as a fixed connection, as a detachable connection, or as a one-piece connection; also as a mechanical connection; or an electrical connection or mutual communication; or may be directly connected or indirectly connected by means of an intermediate medium; or may be internal communication of the two elements or interaction of the two elements. The specific meaning of the above terms in the present application may be understood by one of ordinary skill in the art as the case may be.

For the purposes of this application, unless otherwise expressly specified and limited, that the first feature is “over” or “under” the second feature may include the first feature is in direct contact with the second feature, or may include the first feature is not in direct contact with the second feature, but by means of a separate feature therebetween. Furthermore, that the first feature is “on”, “above” and “over” the second feature includes the first feature is directly above and diagonally above the second feature, or simply indicating that the first feature is horizontally higher than the second feature. That the first feature is “below”, “under”, and “beneath” the second feature includes the first feature is directly below and diagonally below the second feature, or simply indicating that the first feature is horizontally smaller than the second feature.

The following disclosure provides many different embodiments or examples for implementing the different structures of the present application. In order to simplify the disclosure of the present application, components and arrangements of specific examples are described below. Of course, they are merely examples and are not intended to limit the application. In addition, the present application may repeat reference numerals and/or reference letters in various instances, such repetition being for the purpose of simplicity and clarity, without itself indicating a relationship between the various embodiments and/or arrangements discussed. In addition, the present application provides examples of various specific processes and materials, but one of ordinary skill in the art will recognize the application of other processes and/or the use of other materials.

The embodiments of the present application provide an optical fiber etching device. Detailed descriptions are given below.

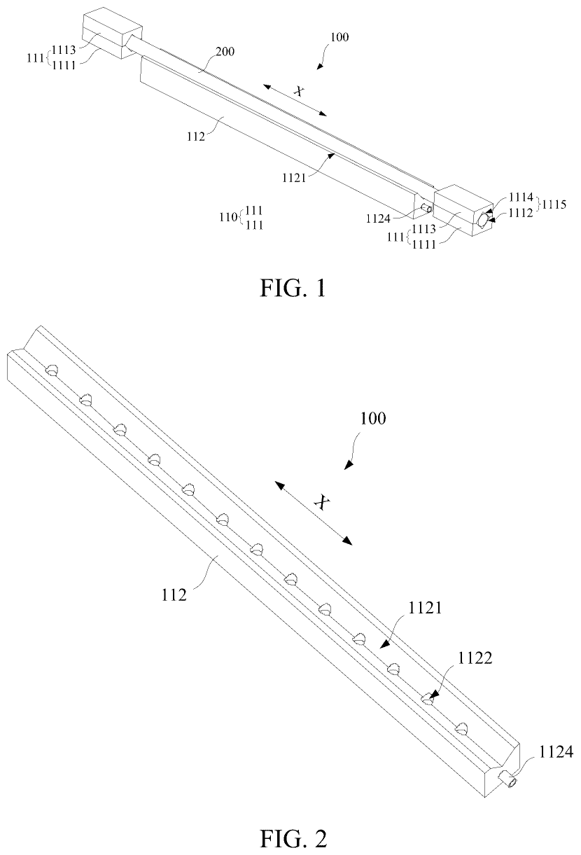

FIG. 1 is a schematic structural diagram of an optical fiber etching device according to an embodiment of the present application. As shown in FIG. 1, an optical fiber etching device 100 includes a base (not shown), a clamping assembly 110, and an etching assembly (not shown). The clamping assembly 110 includes two clamping members 111 spaced apart on the base in a first direction X. The two clamping members 111 are used for clamping an optical fiber 200 to achieve positioning of the optical fiber 200. The etching assembly is used to etch the surface of the optical fiber 200 to form an adjoining surface or other structure at the surface of the optical fiber 200.

The etching assembly includes a laser for generating a laser, and a moving mechanism connected to the laser and configured for driving the laser to move so that the laser light etches the optical fiber 200 along a length direction of the optical fiber 200.

Specifically, the moving mechanism is used to drive the laser to move along the length direction of the optical fiber 200. The laser includes a galvanometer assembly located in the optical path of the laser light. The galvanometer assembly is used to convert the laser light into a scanning laser light. The scanning direction of the scanning laser light is at an included angle with respect to the length direction of the optical fiber 200. That is, the laser light generated by the laser moves along the length direction of the optical fiber 200 while swinging in a direction at an included angle with respect to the length direction of the optical fiber 200.

Alternatively, the moving mechanism may be used to drive the laser to move along the length direction of the optical fiber 200, and to drive the laser to move or swing in a direction at an included angle with respect to the length direction of the optical fiber 200. So, the laser light of the laser may etch the optical fiber 200 along the length direction of the optical fiber 200.

Of course, the laser light of the laser may be irradiated on the optical fiber 200, and the moving mechanism is used to drive the laser to move along the length direction of the optical fiber 200, so that the laser light of the laser etches the optical fiber 200 along the length direction of the optical fiber 200.

In some embodiments, the optical fiber etching device 100 further includes a tensile force measuring member (not shown) for measuring a tensile force to which the optical fiber 200 is subjected. Thus, before the optical fiber 200 is etched by the optical fiber etching device 100, the optical fiber 200 may be clamped by the clamping member 110 and the tensile force applied to the optical fiber 200 is adjusted. Then, the tensile force applied to the optical fiber 200 is measured by the tensile force measuring member. When the tensile force applied to the optical fiber 200 is within a predetermined range, it is explained that the optical fiber 200 is straightened. Then, the optical fiber 200 is etched by the etching member 100. Therefore, it can ensure that the optical fiber 200 is kept in a straight state during the etching process, so that the accuracy of etching the optical fiber 200 by the etching assembly is improved, and an adjoining surface with high accuracy is formed at the surface of the optical fiber 200.

In some embodiments, at least one clamping member 111 is slidably connected to the base in the first direction X, and the tensile force measuring member is provided on the base and connected to the clamping member 111 slidably provided on the base, so as to detect the tensile force to which the clamping member 111 is subjected.

It will be appreciated that, by slidably connecting the clamping member 111 to the base in the first direction X and connecting the tensile force measuring member to the clamping member 111, the tensile force to which the optical fiber 200 is subjected is fed back to the tensile force measuring member through the clamping member 111 slidably connected to the base, thereby achieving measurement of the tensile force to which the optical fiber 200 is subjected.

Of course, the tensile force measuring member may be provided between the optical fiber 200 and the clamping member 111. Thus, the tensile force measuring member is directly connected to the optical fiber 200. When the optical fiber 200 is subjected to the tensile force, the tensile force measuring member may directly detect the tensile force to which the optical fiber 200 is subjected.

It should be noted that, in the embodiments of the present application, the two clamping members 111 may each be slidably connected to the base in the first direction X, or only one clamping member 111 may be slidably connected to the base in the first direction X. When the two clamping members 111 are respectively slidably connected to the base in the first direction X, the optical fiber etching device 100 may include two tensile force measuring members. The two tensile force measuring members are respectively provided on the base and are connected in one-to-one correspondence with the two clamping members 111. Or, the optical fiber etching device 100 may include one tensile force measuring member, which is connected to one of the clamping members 111. Of course, the former may further accurately detect the size of the tensile force to which the optical fiber 200 is subjected.

As shown in FIG. 1, the clamping member 111 includes a connecting seat 1111, and a clamper 1113 movably connected to the connecting seat 1111. The clamper 1113 has a clamping position (as shown in FIG. 1) and a release position. When the clamper 1113 is in the clamping position, a clamping space 1115 for clamping the optical fiber 200 is formed between the clamper 1113 and the connecting seat 1111. When the clamper 1113 is in the release position, the optical fiber 200 is released.

In some embodiments, the clamping spaces 1115 of the two clamping members 111 extend in the first direction X, respectively. This makes it possible to enable a portion of the optical fiber 200 sandwiched between the two clamping members 111 more straight. Specifically, a side of the clamper 1113 facing toward the connecting seat 1111 is provided with a first recess 1114 which penetrates through the clamper 1113 in the first direction X. A side of the connecting seat 1111 facing toward the clamper 1113 is provided with a second recess 1112 which penetrates through the connecting seat 1111 in the first direction X. When the clamper 1113 is in the clamping position, the first recess 1114 of the clamper 1113 and the second recess 1112 of the connecting seat 1111 enclose to form the clamping space 1115. In the first direction X, the clamping spaces 1115 of the two clamping members 111 coincide with each other.

In some embodiments, the connecting seat 1111 of the clamping member 111 may be slidably connected to the base in the first direction X so that the clamping member 111 is slidably connected to the base in the first direction X. The tensile force measuring member may be connected to the connecting seat 1111 of the clamping member 111, or may be connected to the clamper 1113 of the clamping member 111, as long as the tensile force to which the optical fiber 200 is subjected is detected.

In some embodiments, the optical fiber etching device 100 further includes a torsional force measuring member (not shown) for measuring the torsional force to which the optical fiber 200 is subjected.

It will be appreciated that, if the optical fiber 200 is clamped in a twisted state by the clamping assembly 110, the optical fiber 200 is removed from the clamping assembly 110 and automatically returned to be in a non-twisted state after the optical fiber 200 is etched by the etching assembly. At this time, the adjoining surface or other structures formed by etching at the surface of the optical fiber 200 is twisted, thereby affecting the accuracy of the adjoining surface or other structures of the optical fiber 200.

According to an embodiments of the present application, the optical fiber etching device 100 measures the torsional force applied to the optical fiber 200 by the torsional force measuring member. Before the optical fiber 200 is etched by the optical fiber etching device 100, the optical fiber 200 may be clamped by the clamping assembly 110 and the torsional force applied to the optical fiber 200 is adjusted, and then the torsional force applied to the optical fiber 200 is measured by the tensile force measuring member. When the torsional force applied to the optical fiber 200 is within the predetermined range, it is indicated that the optical fiber 200 is straightened. Then, the optical fiber 200 is etched by the etching assembly, thereby ensuring that the optical fiber 200 remains in a straightened state during the etching of the optical fiber 200. In this way, the accuracy of etching the optical fiber 200 by the etching assembly is improved, thereby forming a high-precision adjoining surface or other structure at the surface of the optical fiber 200.

In some embodiments, the torsional force measuring member includes a torsional force sensor provided on a side of the clamper 1113 facing toward the clamping space 1115 or a side of the connecting seat 1111 facing toward the clamping space 1115. As a result, when the clamper 1113 and the connecting seat 1111 clamp the optical fiber 200, the torsional force sensor may directly detect the torsional force to which the optical fiber 200 is subjected. Of course, the torsional force measuring member may measure the torsional force, to which the optical fiber 200 is subjected, in another manner, as long as the torsional force to which the optical fiber 200 is subjected to is accurately measured.

In some embodiments, as shown in FIGS. 1-3, the optical fiber etching device 100 further includes a positioning member 112 disposed between the two clamping members 111 of the clamping assembly 110 and in contact with a portion of the optical fiber 200 between the two clamping members 111 to position the portion of the optical fiber 200 between the two clamping members 111. So, the portion of the optical fiber 200 between the two clamping members 111 remains in a more straight state to further improve the accuracy of etching the optical fiber 200 by the optical fiber etching device 100.

The positioning member 112 includes a positioning groove 1121 extending in the first direction X and extending through the positioning member 112. The positioning groove 1121 is configured to receive the optical fiber 200. An inner surface of the positioning groove 1121 is configured to abut against an outer peripheral surface of the optical fiber 200 to position the optical fiber 200, so that the optical fiber 200 remains in a straight state. In the laser etching process for the optical fiber 200, the optical fiber 200 is prevented from being deformed caused by vibration or completely to affect the accuracy of etching the optical fiber 200.

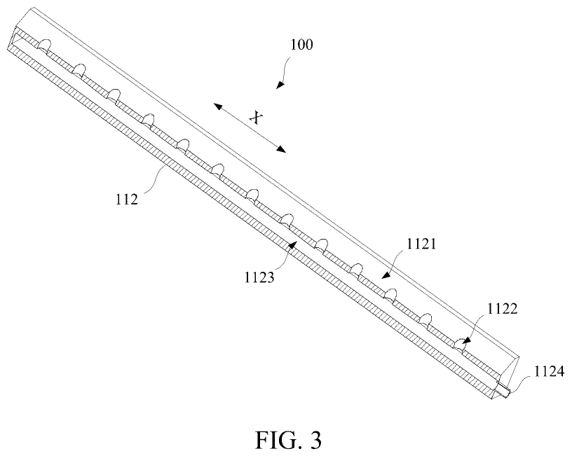

In some embodiments, as shown in FIGS. 2 and 3, an inner surface of the positioning groove 1121 of the positioning member 112 is provided with adsorption hole(s) 1122, which are in communication with a suction member (not shown). After the optical fiber 200 is placed in the positioning groove 1121 of the positioning member 112, the negative pressure is applied to the adsorption holes 1122 through the suction member, so that the adsorption holes 1122 may absorb the optical fiber 200 to the inner surface of the positioning groove 1121. Thus, it may further improve the positioning effect of the positioning groove 1121 of the positioning member 112 on the optical fiber 200, thereby making the accuracy of processing the optical fiber 200 higher.

The number of the adsorption holes 1122 is multiple, and the multiple adsorption holes 1122 are sequentially distributed at intervals along the first direction X to further improve the adsorption effect on the optical fiber 200.

Specifically, as shown in FIG. 3, the positioning member 112 is provided with a cavity 1123 extending in the first direction X. A first end of each of the plurality of adsorption holes 1122 is in communication with the positioning groove 1121, and the other end of the adsorption hole 1122 is in communication with the cavity 1123. An outer surface of the positioning member 112 is provided protrudedly with a connector 1124 in communication with the cavity 1123. The connector 1124 is used for communicating with the suction member so that the plurality of adsorption holes 1122 communicate with the suction member. The connector 1124 protrudes from a surface of a side of the locating member 112 which is in the first direction X.

In some embodiments, the optical fiber etching device 100 further includes a gas pressure sensor (not shown) in communication with the adsorption holes 1122 to detect the gas pressure within the adsorption holes 1122. It is understood that after the optical fiber 200 is placed in the positioning groove 1121 of the positioning member 112, the air pressure in the adsorption holes 1122 is detected by the air pressure sensor, so it is possible to confirm whether the adsorption holes 1122 adsorb the optical fiber 200 into the positioning groove 1121 of the positioning member 112. Further, in the process of etching the optical fiber 200 by the laser light, it is possible to determine whether the optical fiber 200 is deformed by detecting the air pressure in the adsorption holes 1122.

The air pressure sensor may communicate with the connector 1124 of the positioning member 112 to indirectly detect the air pressure in the adsorption holes 1122 by detecting the air pressure in the cavity. Alternatively, the gas pressure sensor may be provided in the cavity to directly detect the gas pressure in the cavity, and thus the gas pressure in the adsorption holes 1122 is indirectly detected.

In some embodiments, the material of the positioning member 112 is a metallic material. The laser includes a carbon dioxide laser. Since a absorption rate of the metal on the laser light generated by the carbon dioxide laser is very low, by making the material of the positioning member 112 to be the metallic material, it is possible to avoid the problem that the temperature of the positioning member 112 is caused to rise to even damage due to the laser light of the laser is absorbed too much, when the optical fiber 200 is etched by the laser light of the laser.

In some embodiments, the laser may be opposed to an opening of the positioning groove 1121. Alternatively, the laser may be positioned on a side of the positioning member 112. Then, the laser light generated by the laser may etch a portion of the optical fiber 200 extending out of the opening of the positioning groove 1121, and the portion of the optical fiber 200 located in the positioning groove 1121 is remained, thereby further improving the etching accuracy of the laser light on the optical fiber 200.

Embodiments of the present application further provide an optical fiber etching device 100 including a base, a clamping assembly 110, two tensile force measuring members, a torsional force measuring member and an etching assembly. The clamping assembly 110 includes two clamping members 111 disposed on the base at intervals in a first direction X. The clamping member 111 includes a connecting seat 1111 disposed on the base, and a clamper 1113 movably connected to the connecting seat 1111. The clamper 1113 have a clamping position and a release position. When the clamper 1113 is in the clamping position, a clamping space 1115 for clamping an optical fiber 200 is formed between the clamper 1113 and the connecting seat 1111. When the clamper 1113 is in the release position, the clamper 1113 releases the optical fiber 200. The connecting seats 1111 of the two clamping members 111 are respectively slidably connected to the base in the first direction X. The clamping spaces 1115 of the two clamping members 111 extend in the first direction X, respectively. In the first direction X, the clamping spaces 1115 of the two clamping members 111 coincide with each other. Two tensile force measuring members are used for measuring the tensile force to which the optical fiber 200 is subjected. The two tensile force measuring members are respectively provided on the base and connected in one-to-one correspondence with the connecting seats 1111 of the two clamping members 111. The torsional force measuring member includes a torsional force sensor provided on a side of the clamper 1113 facing toward the clamping space 1115 or a side of the connecting seat 1111 facing toward the clamping space 1115. The etching assembly includes a laser for generating laser light and a moving mechanism connected to the laser and configured for driving the laser to move, so that the laser light etches the optical fiber 200 along the length direction of the optical fiber 200.

In the above-mentioned embodiments, the description of each embodiment has its own emphasis, and parts not described in detail in a certain embodiment may be referred to the related description of other embodiments.

The present application has been described in detail with reference to an optical fiber etching device according to an embodiment of the present application. Specific examples are used herein to illustrate the principles and the embodiments of the present application. The description of the above embodiments is merely provided to assist in understanding the technical solution of the present application and the core concepts thereof. It will be appreciated by those of ordinary skill in the art that modifications may still be made to the technical solutions described in the foregoing embodiments, or equivalents may be made to some of the technical features therein; These modifications or the substitutions do not depart the essence of the corresponding technical solutions from the scope of the technical solutions of the embodiments of the present application.

What is claimed is:

1. An optical fiber etching device, comprising:
a base;
a clamping assembly comprising two clamping members arranged on the base at intervals in a first direction, wherein the two clamping members each comprise a connecting seat arranged on the base, and a clamper movably connected with the connecting seat; the clamper has a clamping position and a releasing position; when the clamper is in the clamping position, a clamping space for clamping an optical fiber is formed between the clamper and the connecting seat; when the clamper is in the releasing position, the optical fiber is released; the connecting seat of each of the two clamping members is slidably connected with the base in the first direction, and the clamping space of each of the two clamping members extends in the first direction; and the clamping space of one of the two clamping members coincides with the clamping space of another one of the two clamping members in the first direction;
two tensile force measuring members for measuring a tensile force applied to the optical fiber, wherein the two tensile force measuring members are each provided on the base and are each connected to the connecting seat of a corresponding one of the two clamping members;
a torsional force measuring member comprising a torsional force sensor for measuring a torsional force applied to the optical fiber, wherein the torsional force sensor is provided on a side of the clamper facing toward the clamping space or a side of the connecting seat facing toward the clamping space;
an etching assembly comprising a laser for generating laser light and a moving mechanism, wherein the moving mechanism is connected to the laser and configured for driving the laser to move so that the laser light etches the optical fiber along a length direction of the optical fiber; and
a positioning member provided between the two clamping members of the clamping assembly, wherein the positioning member comprises a positioning groove extending in the first direction and extending through the positioning member, the positioning groove is configured for receiving the optical fiber, an inner surface of the positioning groove is configured for abutting against an outer peripheral surface of the optical fiber, one or more adsorption holes formed in the inner surface of the positioning groove, and the one or more adsorption holes are configured to be in communication with a suction member.

2. The optical fiber etching device according to claim 1, wherein the one or more adsorption holes comprise a plurality of adsorption holes, and the plurality of the adsorption holes are sequentially distributed at intervals in the first direction.

3. An optical fiber etching device, comprising:
a base;
a clamping assembly comprising two clamping members arranged on the base at intervals in a first direction, wherein the two clamping members are configured for clamping an optical fiber;
one or more tensile force measuring members for measuring a tensile force to which the optical fiber is subjected;
an etching assembly comprising a laser for generating laser light and a moving mechanism, wherein the moving mechanism is connected to the laser and configured for driving the laser to move so that the laser light etches the optical fiber along a length direction of the optical fiber;
a torsional force measuring member for measuring a torsional force to which the optical fiber is subjected; and
a positioning member disposed between the two clamping members of the clamping assembly, wherein the positioning member comprises a positioning groove extending in the first direction and extending through the positioning member, the positioning groove is configured for receiving the optical fiber, and an inner surface of the positioning groove is configured for abutting against an outer peripheral surface of the optical fiber.

4. The optical fiber etching device according to claim 3, wherein at least one of the two clamping members is slidably connected to the base in the first direction, and the tensile force measuring member is provided on the base and is connected to the clamping member slidably provided on the base, so as to detect the tensile force to which the clamping member is subjected.

5. The optical fiber etching device according to claim 4, wherein the two clamping members are slidably connected to the base in the first direction; the optical fiber etching device comprises two of the one or more tensile force measuring members, and the two tensile force measuring members are provided on the base and are connected to the two clamping members in one-to-one correspondence.

6. The optical fiber etching device according to claim 3, wherein the two clamping members each comprise a connecting seat provided on the base, and a clamper movably connected to the connecting seat; the clamper have a clamping position and a releasing position; a clamping space for clamping the optical fiber is formed between the clamper and the connecting seat when the clamper is in the clamping position, and the optical fiber is released when the clamper is in the releasing position.

7. The optical fiber etching device according to claim 6, wherein the clamping space of each of the two clamping members extends in the first direction.

8. The optical fiber etching device according to claim 3, wherein the two clamping members each comprise a connecting seat provided on the base, and a clamper movably connected to the connecting seat; the clamper have a clamping position and a releasing position; a clamping space for clamping the optical fiber is formed between the clamper and the connecting seat when the clamper is in the clamping position, and the optical fiber is released when the clamper is in the releasing position; and the torsional force measuring member comprises a torsional force sensor provided on a side of the clamper facing toward the clamping space or a side of the connecting seat facing toward the clamping space.

9. The fiber etching device according to claim 3, wherein the laser comprises a carbon dioxide laser.

10. The optical fiber etching device according to claim 3, wherein the moving mechanism is configured for driving the laser to move along the length direction of the optical fiber, the laser comprises a galvanometer assembly located in an optical path of the laser light, the galvanometer assembly is configured for converting the laser light into a scanning laser light, and a scanning direction of the scanning laser light is at an included angle with respect to the length direction of the optical fiber.

11. The optical fiber etching device according to claim 3, wherein the positioning member is made of a metallic material.

12. The optical fiber etching device according to claim 3, wherein the laser is located on a side of the positioning member, and the laser light generated by the laser is configured to etch away a portion of the optical fiber protruding out of an opening of the positioning groove and to retain a portion of the optical fiber located in the positioning groove.

13. The optical fiber etching device according to claim 3, wherein the laser is opposite to an opening of the positioning groove.

14. The optical fiber etching device according to claim 3, wherein the inner surface of the positioning groove is provided with one or more adsorption holes configured for communicating with a suction member.

15. The optical fiber etching device according to claim 14, wherein the one or more adsorption holes comprise a plurality of adsorption holes, and the plurality of adsorption holes are sequentially distributed at intervals in the first direction.

16. The optical fiber etching device according to claim 14, wherein the positioning member comprises a cavity extending in the first direction, a first end of each of the one or more adsorption holes is in communication with the positioning groove, and an other end of the adsorption hole is in communication with the cavity.

17. The optical fiber etching device according to claim 16, wherein an outer surface of the positioning member is protrudedly provided with a connector in communication with the cavity, and the connector is configured for communicating with the suction member so that the one or more adsorption holes are in communication with the suction member.

18. The optical fiber etching device according to claim 17, further comprising a gas pressure sensor in communication with the one or more adsorption holes to detect gas pressure in the one or more adsorption holes.

19. The optical fiber etching device according to claim 18, wherein the gas pressure sensor is in communication with the connector.

20. The optical fiber etching device according to claim 18, wherein the pressure sensor is disposed within the cavity.
